(19) United States
(12) Patent Application Publication
(10) Pub. No.: US 2020/0134235 A1
(43) Pub. Date: Apr. 30, 2020

(54) PHYSICAL AND LOGICAL ATTACK RESILIENT POLYMORPHIC HARDWARE

(71) Applicant: KameleonSec Ltd., Caesaria (IL)

(72) Inventors: Efi SASSON, Kfar Tavor (IL); Jorge MYSZNE, Mountain View, CA (US); Ronen TANNE, Vancouver (CA)

(73) Assignee: KameleonSec Ltd., Caesaria (IL)

(21) Appl. No.: 16/670,110

(22) Filed: Oct. 31, 2019

Related U.S. Application Data
(60) Provisional application No. 62/753,492, filed on Oct. 31, 2018.

(51) Int. Cl. G06F 21/76; G06F 21/75; G06F 21/56; G06F 21/57; H04L 9/00; H04L 29/06

(52) U.S. Cl. CPC G06F 21/76; G06F 21/755; G06F 21/566; H04L 2209/12; H04L 9/003; H04L 63/1491; G06F 2221/2125; G06F 21/575

(57) ABSTRACT

An attack resilient distributed proactive polymorphic hardware, the including: at least one polymorphic core including at least one polymorphic logic, the at least one polymorphic logic adapted to adjust an implementation of a proactive polymorphic model without changing the contextual functionality of the proactive polymorphic model; a framework list defining at least one policy to be executed by the proactive polymorphic model; and a graph designating a historical description of each of the at least one policy executed by the proactive polymorphic model.

### CROSS-REFERENCE TO RELATED APPLICATIONS

This application claims the benefit of U.S. Provisional Application No. 62/753,492 filed on Oct. 31, 2018, the contents of which are hereby incorporated by reference.

### TECHNICAL FIELD

The present disclosure relates generally to cybersecurity and more specifically to the field of polymorphic hardware devices and chip design configured and/or trained for enhanced security, authentication, and identification of connected devices, hardware, and co-hardware/software functionality.

### BACKGROUND

Today's hardware devices are used for security-critical tasks, either as stand-alone devices or as hardware functions inside a more general-purpose device. Uses for these security-critical devices fall along a broad range, including access control management, security for sensors, wearables and other IoT devices, automotive applications, infrastructure systems, servers, data centers, and the like. These devices and secure functions executed thereon are used to access, generate, and process security and privacy data information.

As an example, some of today's evolving security flows incorporate the use of physical unclonable functions (PUF). A PUF is a “digital fingerprint” that serves as a unique identity for a semiconductor device such as a microprocessor. They are based on slight physical variations that naturally occur during a semiconductor's manufacturing, and which can be used to differentiate between otherwise identical semiconductors. A PUF can therefore be relied on to create a unique identification (ID) of a hardware device or to generate a device-specific secure key. These unique IDs and secure keys are often used in cryptography and similar high security applications.

Current PUF designs have limitations, however, as they are discrete, deterministic, and passive primitive building blocks that receive homogenous control triggers and challenges and return responses that are passively related to silicon coordinates where the PUF is physically located. The responses of current PUF designs are not related to the device (or chip) functions, architecture, and operation modes, neither at run time in an operational mode nor at rest, but rather to the unique hardware itself which cannot be changed. Thus, the same challenge presented to a particular device will always return the same response regardless of the device functionality or its operation mode.

Using such deterministic and passive hardware has been proven to be insecure. Weakness studies have been performed by using machine learning techniques to predict the behavior of such hardware after a certain number of prior challenges and responses have been observed. Research has further shown that delay-based deterministic implementations are vulnerable to side channel attacks.

In addition to non-invasive approaches, such as modeling and side channel attacks, there are other hardware related attacks that passive and deterministic hardware or co-hardware/software can be vulnerable to. These include differential power analysis (DPA) attacks, probing, memory corruption attacks, and the like, which make the current deterministic hardware design vulnerable and prone to exploits of various kinds. While deterministic hardware is based on a passive logic, it often requires an additional logic to operate or mange the hardware in the form of software or additional hardware, which both may be vulnerable to logical memory corruption attacks related to software logic, DPA or other types of side channel attacks, or fault injections attacks in case of a passive and deterministic hardware or software logic.

Because most current security hardware is passive and deterministic, specifically at run time, information about how such a system is running is constantly being exposed to varying degrees. Even if such hardware is configured to execute polymorphic software on a discrete CPU, the instruction set for the discrete hardware CPU will remain the same, and thus such a setup only provides protection from memory corruption of the application it protects but not from vulnerabilities that exist within the polymorphic software engine itself, nor from vulnerabilities that exist within the related co-software/hardware architecture and flows, such as side channel attacks with cache or on chip memory attacks. Further, such hardware is vulnerable to differential power analysis attacks, which is a product of the determinism and discrete characteristics of the co-software/hardware architecture and flows. If a bad actor gains access to information about a system running such hardware, the functionality can be copied, modified, emulated, manipulated, or tampered with to execute malicious code. The malicious code may affect the co-software/hardware functionality or authenticity, and may leak relevant co-software/hardware data, which can affect the operation and the privacy which the system is target to protect. Providing a different architecture and functionality of the co-software/hardware is essential for having a system which can prevent such vulnerabilities.

These and other vulnerabilities also exist on generic field programmable gate array (FPGA) types of embedded logic or devices, as the technology is built for generic usage and not for security. For example, FPGA are often configured as cells that are slaves to an external programmer or FPGA development flow tools, which can be used by attackers to overcome the security mechanisms that have been previously programmed.

FPGA technology is built using generic slaves cells, which are reflected as generic libraries to the external FPGA design tools and manipulated by external designers which can create the designs of the FPGA in generic high level Register Transfer Level (RTL) languages, such as C, System-C, Verilog, System-Verilog, VHDL and the like. These are generic languages and technology which attackers can exploit to overcome security designed mechanisms by using the known FPGA technology to their advantage.

Polymorphing techniques that rely on FPGA technology by reprogramming the FPGA with newly selected designs have been proven insecure because of the above description, are therefore vulnerable to attacks.

Mounting an effective defense from such attacks is especially critical when there is a need to protect security-critical systems, such as enterprise, industrial, automotive, governmental, and similar critical infrastructure systems. However, creating a non-deterministic security driven hardware model is challenging to both create and implement.

It would therefore be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include an attack resilient distributed proactive polymorphic hardware, including: at least one polymorphic core including at least one polymorphic logic, the at least one polymorphic logic adapted to adjust an implementation of a proactive polymorphic model without changing the contextual functionality of the proactive polymorphic model; a framework list defining at least one policy to be executed by the proactive polymorphic model; and a graph designating a historical description of each of the at least one policy executed by the proactive polymorphic model.

Certain embodiments disclosed herein also include a polymorphic core, including: at least one hardware logic configured to execute specific functions of a proactive polymorphic model; and a polymorphic logic, wherein the polymorphic logic includes a decision mechanism and at least one neuron.

Certain embodiments disclosed herein also include a method of establishing a topology of a proactive polymorphic model, including: activating an application topology for a proactive polymorphic model, wherein the application topology is based on an infrastructure topology of the application topology; activating a security topology of a proactive polymorphic model, wherein the security topology is based on an infrastructure topology.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a proactive polymorphic hardware configured to be resilient to both physical and logical attacks according to an embodiment.

FIGS. 2A and 2B are block diagrams of a proactive polymorphic model implementing proactive polymorphic hardware according to an embodiment.

FIG. 3 is a block diagram of a polymorphic core of a proactive polymorphic model according to an embodiment.

FIGS. 4A and 4B are a block diagrams of a distributed polymorphic hardware system according to an embodiment.

FIG. 5 is an example flowchart illustrating a method of establishing a topology of a proactive polymorphic model.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include proactive polymorphic hardware that provides a shifting and adjustable architectural structure for an integrated circuit. The proactive polymorphic hardware is configured and/or trained to randomly alter the implementation and location of operations while conserving an application's original operational and functional characteristics, thus protecting the hardware from malicious attacks, such as differential power analysis, memory corruption attacks, side channel attacks, physical and or logical attacks and the like. The proactive polymorphic hardware not only allows for morphing of the physical hardware, but isolating the hardware or software, managing the hardware or software, selecting only parts of the hardware or software to execute various commands, authenticating the hardware, securing the hardware (e.g., via cryptographic tunneling within the hardware), sanitizing the hardware and/or software, and partitioning the hardware and/or software.

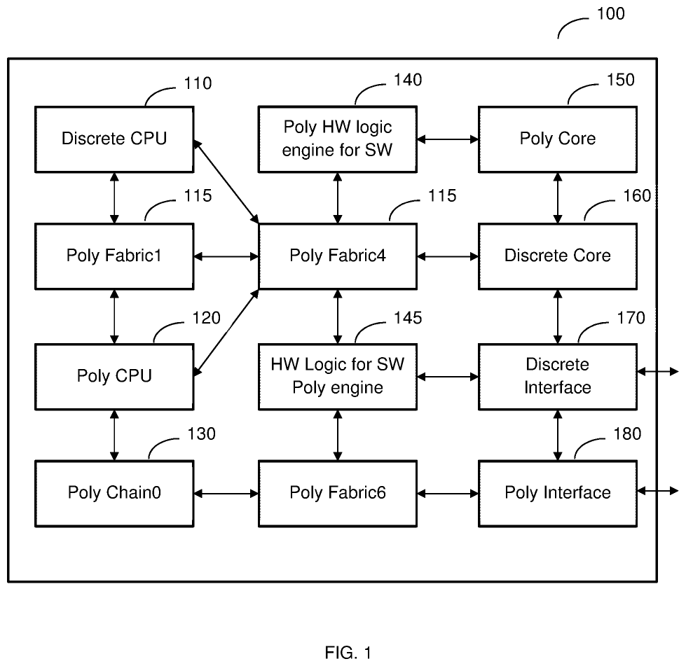

FIG. 1 shows a schematic diagram of a proactive polymorphic hardware 100 configured and/or trained to be resilient to both physical and logical attacks according to an embodiment. The proactive polymorphic hardware 100 is composed of multiple hardware elements, including CPUs, fabrics, memories, interfaces, and cores. The proactive polymorphic hardware 100 may include both a discrete and deterministic CPU 110 as well as one or more polymorphic CPUs 120. A polymorphic CPU 120 is a processing circuitry configured and/or trained to have its implementation adjusted while delivering, and without changing, the contextual functionality and output. Contextual here refers to two or more outputs sharing the same value or values similar enough that fall within an acceptable range. While currently adjustable circuitries include field programming gate arrays (FPGAs) which are not designed for security use per se, as described above, those circuitries will change their output when their configurations are adjusted by FPGA development tools, unlike the polymorphic CPU 120.

The proactive polymorphic hardware 100 further includes a polymorphic chain 130 of previously executed policies which may also include the distributed system infrastructure for the chip level, a polymorphic fabric 115 configured and/or trained to provide an interface between internal elements of the proactive polymorphic hardware 100, and discrete 150 and polymorphic 160 cores configured and/or trained to execute policies of the proactive polymorphic hardware 100. Additionally, the proactive polymorphic hardware 100 includes discrete 170 and a polymorphic 180 interfaces configured and/or trained to connect the proactive polymorphic hardware 100 with an external device or system, such as a distributed network, e.g., a distributed ledger such as a blockchain (not shown).

In an embodiment, the proactive polymorphic hardware 100 further includes a polymorphic hardware logic 140 and a hardware logic of polymorphic software 145, which are engines configured and/or trained to receive software binaries, access and create graphs, and create polymorphism in software to be executed either on a polymorphic CPU 120 or on a discrete deterministic CPU 110. Software shall be construed broadly to mean any type of instructions, whether referred to as software, firmware, middleware, microcode, hardware description language, or otherwise. Instructions may include code, e.g., in source code format, binary code format, executable code format, or any other suitable format of code.

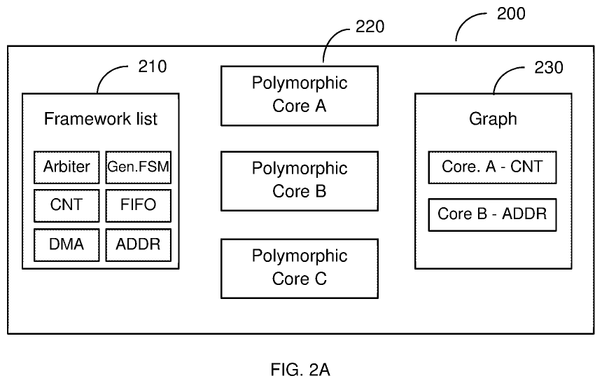

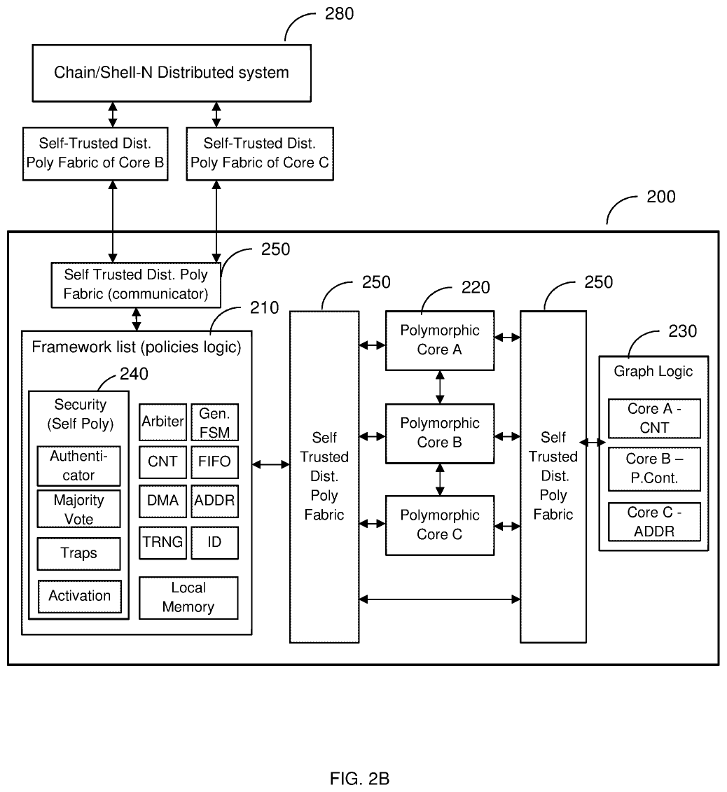

FIG. 2A shows a block diagram of a polymorphic model 200 implementing proactive polymorphic hardware. In order to establish a polymorphic model 200, a framework list 210 is generated during the device's development phase. This framework list 210 contains the information of the policies or functionalities to be implemented by the proactive polymorphic cores 220 of the device 200 in order to execute all or part of the device. The framework list 210 may include, for example, one or more counters (CNT), dividers, direct memory access (DMA) engines, a framework for generation of a non-deterministic finite-state machines (FSM), arbiters, memory address pointers, first-in-first-out (FIFO) memory policies, and the like. The framework list 210 may be stored locally, semi hardened by pre-silicon design, e.g., on a die, or remotely accessed over a network (not shown), such that the proactive polymorphic model 200 can access the framework list 210, either in an encrypted or a plain text format.

An FSM is a structural sequential computational model with a finite number of states, where the FSM can only be in a single state at a time, analogous to a CPU control flow when the CPU runs a single instruction at a time. The outputs of the FSM will be dependent on the inputs given, as well as the current and next state. The FSM included in the framework can be run on a standalone standard logic with programmable and/or trained gates, e.g., an FPGA, ASIC device, SoC device, AI device chip, network device and or any other VLSI based device, or can be a logic configured, trained, or combined with multiple neurons, as described below, to create new models of a polymorphic logic. This FSM is not dependent on VLSI or FPGA tools used after the chip is fabricated, or on an FPGA single programmed and internally polymorphic device.

Upon a wake-up of the proactive polymorphic model 200, each of the one or more polymorphic cores 220, e.g., Polymorphic Core A, B, or C, is configured and/or trained to select a policy to execute, meaning that the core may decide or affect the functionality that the proactive polymorphic model 200 is going to implement, consume, or operate. The policy is part of the overall functionality of the proactive polymorphic model 200 and is chosen from the framework list 210. One or more policies may be selected depending on the desired application.

Once a policy is selected and configured and/or trained, a process of authentication and approval is performed by the proactive polymorphic model 200. The authentication and approval may be performed by the internal polymorphic cores 220. In an embodiment, this process is based on a predetermined majority vote threshold of authentication from all the cores. For example, if the predetermined threshold is 51% for authentication, as long as 51% or more of the polymorphic cores 220 successfully authenticate the policy, it is determined to be approved. Once the policy is approved, the core stores a reference of the policy, e.g., aliases, signatures, or tags in a local or remote location, such as a distributed mechanism, with help of e.g., a blockchain, distributed ledger. Certificates can also be created according the majority vote and stored locally or distributed. This information is used to construct the graph 230 that tracks all policy configurations of the polymorphic cores 220 during the lifetime of the device 200. The graph 230 is updated with each change of a policy by each of the polymorphic cores 200, and thus keeps a historical description, or log, of all of the executed policies.

In an embodiment, subsequent policy selections are based on previously selected policies, which may be stitched together and used to determine future states of the device 200 and policies to be selected and executed. This provides a significant runtime and/or hot swap security feature, as any external bad actor attempting to mimic the device 200 or insert harmful code or logic therein will be unable to do so without access to all previously selected policies, which can also be configured and/or trained to be unique for each device. The first core 220 to decide a policy can be chosen randomly, periodically, or by a predetermined analysis each time a new setup flow begins, e.g., either periodically at runtime, or upon any start-up or reset of the proactive polymorphic model 200 or upon analysis.

The device is configured and/or trained to use the graph 230 and the framework list 210 to polymorph the implementation of the polymorphic cores 220, e.g., along with an FSM configured and/or trained as a decision mechanism. The neurons may be based on different types of trainable logics, such as, but not limited to, a perceptron, a weighted trainable logic or a logical configuration and/or a trainable mechanism which is based on an FSM. The decision mechanism is a function which communicates and integrates with other cores to determine a decision. In an embodiment, the decision mechanism is assigned as a higher priority function, particularly at a device restart.

The implementation, namely the configuration and/or training, and various connections within the proactive polymorphic model 200 can then be adjusted while keeping the intended context application functionality of the device 200, and the like, intact. That is, while the neurons and FSMs are shifting the exact or similar implementation of the proactive polymorphic model 200 over time, the functionality of the device 200 does not change. As a simplified example, the following logic and inputs of 1+3 and 6−2 both deliver the same resulting output while using different implementations. Similarly, the functionality of the proactive polymorphic model 200 remains the same and/or similar while the implementation to achieve that functionality can be ever shifting. Such a configuration and/or training provides additional security to the device 200, as authentication can be configured and/or trained to require specific implementations while excluding others. The disclosed proactive polymorphic model 200 is configured and/or trained to execute policies connected to security features. Such a device 200 may authenticate systems, allow or deny network traffic, permit or prevent access to data, and the like, where each functionality can produce the same and/or similar contextual output (e.g., the same bad actor will always be denied access to secure data), while using morphed and adjusted implementations of the device 200.

The graph 230 includes a history of previous polymorphic cores 220 executed, and in an embodiment the proactive polymorphic model 200 is configured and/or trained to implement a decision tree mechanism, e.g., executed by an FSM, to train or adapt the cores 220 of the proactive polymorphic model 200 based on a previously used elements. These elements can include elements of the framework list 210, and when stitched together, create a unique graph 230.

FIG. 2B shows a more detailed block diagram of a proactive polymorphic model 200 implementing proactive polymorphic hardware according to an embodiment. In an embodiment, the proactive polymorphic model 200 further includes at least one self-trusted distributed polymorphic fabric 250. The fabric 250 provides an interface between multiple components of the proactive polymorphic model 200, including between the polymorphic cores 220 and the framework list 210, between the polymorphic cores 220 and the graph logic, and between the framework list 210 and an external distributed system 280. In an embodiment, the fabric 250 is created by a polymorphic FSM (not shown) and provides a secure connection between two or more secure elements or cores. In an embodiment, the fabric 250 is distributed, such that the secure tunnel of communication passing through the fabric 250 also requires authentication, e.g., via a majority vote, to allow the passage of information between the device elements. The fabric 250 is self-trusted in that there is no need for an external or user input to authenticate the fabric 250, as its security is ensured by its distributed configuration and/or training.

As shown in FIG. 2B, the framework list 210 may include additional elements, including traps within the proactive polymorphic model 200, which may include honeypots (e.g., sending suspicious activity to a sandbox), canary logics (e.g., allowing the policies to be executed, but sending alerts and/or signaling of suspicious activities), hooking logics (e.g., altering the executed policies when suspicious activity is detected), and the like. The framework list 210 may further include a majority vote mechanism determining how a majority vote is executed and what thresholds are necessary for a decision to be accepted.

An activation module and/or a policy within the framework list 210 ensures that the selected functionality of a policy is legitimately chosen, e.g., via an FSM configured and/or trained to activate the policy only when a specific authentication sequence is executed. Otherwise, activation is denied.

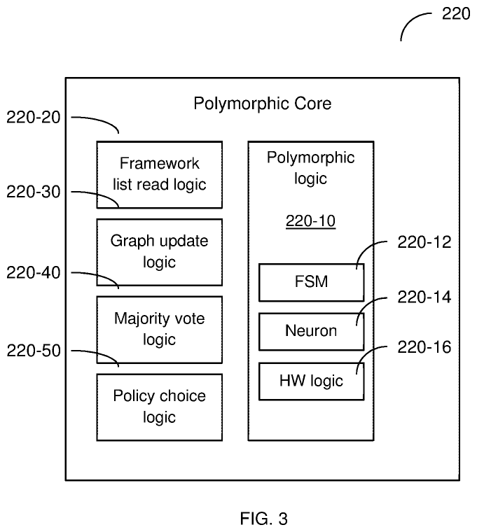

FIG. 3 is a block diagram of a polymorphic core 220 of a proactive polymorphic model according to an embodiment. The polymorphic core 220 includes multiple hardware logics configured and/or trained to execute specific functions of the proactive polymorphic model, such as a polymorphic logic 220-10 and additional logics configured and/or trained for specific tasks, including a framework list read logic 220-20, a graph update logic 220-30, a majority vote logic 220-40, and a policy choice logic 220-50. In an embodiment, each logic has a polymorphic structure, such that their individual implementations shift and morph, e.g., via the polymorphic logic 220-10, while still producing the same or similar desired outputs.

The polymorphic logic 220-10 is configured and/or trained to include an FSM 220-12, and neuron 220-14, and a hardware logic 220-16. In an embodiment, the neuron 220-14 is configured and/or trained to create additional nested neurons, where each neuron configured and/or trained to execute a different policy. In an embodiment, a decision mechanism is a function which communicates and integrates with other cores to determine a specific decision, where the decision mechanism is based on the FSM 220-12.

The polymorphic core 220 is configured and/or trained to execute instructions in a secured manner. In an embodiment, the polymorphic core 220 is configured and/or trained to receive software binaries, access and create graphs, and create polymorphic software to be executed either on a polymorphic logic or on a discrete deterministic logic. The polymorphic core 220 receives a command, e.g., instructions, analyzes the binary of the command, and adapts the binary to the current architecture of the proactive polymorphic model. Thus, for example, if the polymorphic core 220 had previously morphed the address map of a proactive polymorphic model, the command is adapted to be executed and produce the expected outputs while using the updated address map of the device. In this manner, the output is agnostic to the current architecture of the proactive polymorphic model and will consistently produce the expected results.

In an embodiment, the polymorphic cores 220 of the proactive polymorphic model 200 are configured and/or trained to accomplish various hardware-related tasks relating to the hardware of the proactive polymorphic model itself, or hardware connected thereto, including morphing the hardware to a specific state, isolating the hardware from particular system elements, select which parts of the hardware are to be activated and which are to be deactivated, managing and partitioning the hardware as desired, and authenticating the hardware for use in secure applications.

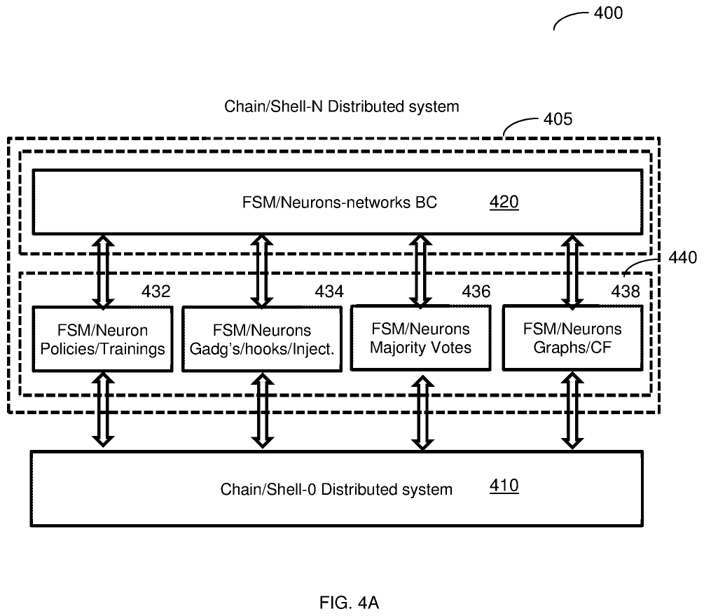

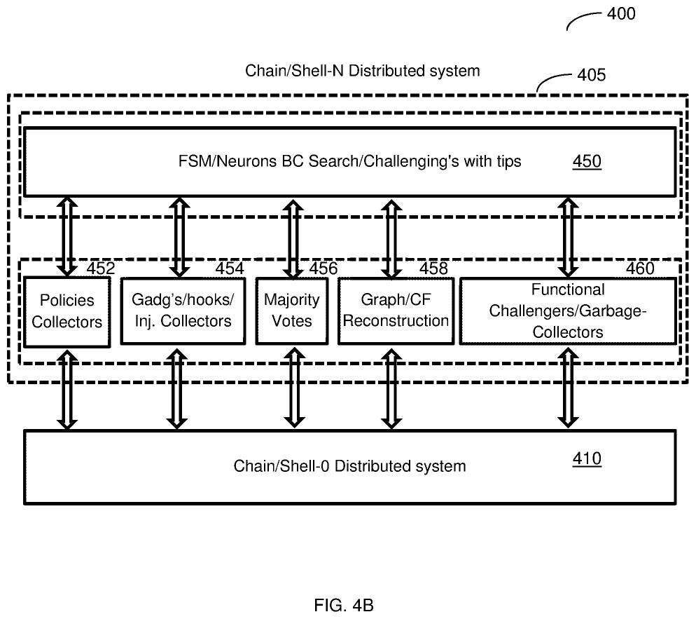

FIG. 4A shows a block diagram of a distributed polymorphic hardware system 400 according to an embodiment. In an embodiment, the system 400 includes a larger distributed chain/shell system 405 that comprises multiple local distributed systems 410 connected together, where the larger distributed system chain/shell 405 include N local distributed system 410, where N is an integer equal to or greater than 1. The local distributed systems 410 comprise one or more polymorphic cores that include an FSM and a neuron, or a gate, configured and/or trained for specific tasks. These include FSM and neurons for managing policies 432, FSM and neurons for executing gadgets, hooks and injections 434 for security purposes, FSM and neurons for authentication via majority voting 436, and FSM and neurons configured and/or trained to track and reference previous policies storing and/or tagged within graphs 438.

The FSM and neuron policies may have generated aliases, signatures, or tags that may be stored within a database 440, either stored locally or remotely, e.g., over a cloud network. In an embodiment, the neurons and FSMs are not executed on generic logics, but rather are execute on logics that are polymorphic and adjustable by design for security orientation.

The local distributed database 410 may be formed into a chain, which further includes gadgets and hooks, and a predetermined majority vote mechanism configured and/or trained to decide how the policies or the cores work, e.g., the minimum amount of cores that must agree or correspond to each other when authenticating a policy. These can all be implemented within the hardware of a proactive polymorphic model, e.g., the device 200 of FIG. 2. The structure of the basic neurons of the system cannot be changed, but the configuration and/or training of the neurons or of the FSM can be. Additionally, different types of nested neurons can be created within the basic neuron, providing additional polymorphic functionality.

FIG. 4B is a block diagram of a distributed polymorphic hardware system 400 according to an embodiment. The local distributed system 410 is configured and/or trained to determine the current state of the system. Included in the larger distributed chain/shell system 405 are various collectors used to determine aspects of one or more local systems, including policy collectors 452 to determine current and previously executed policies of a system; gadget, hooks, and injector collectors 454 to determine the current state of each security device within a system (e.g., if a hook been previously triggered); majority vote collectors 456 to determine the requirements and history of authentication; graph or control flow reconstruction collectors 458; and functional challengers 460 to establish the authorization status of a system based on challenge responses, and garbage collectors 460 and to sanitize resources no longer used. Each of these collectors contribute to determining the current state of a proactive polymorphic model. The aliases, signatures, or tags of the FSM and neurons of each of the systems can be stored in a distributed manner. In an embodiment, the signatures of the implemented FSM and neurons are distributed over a blockchain ledger 450, either locally or remotely, such as over a cloud computing system.

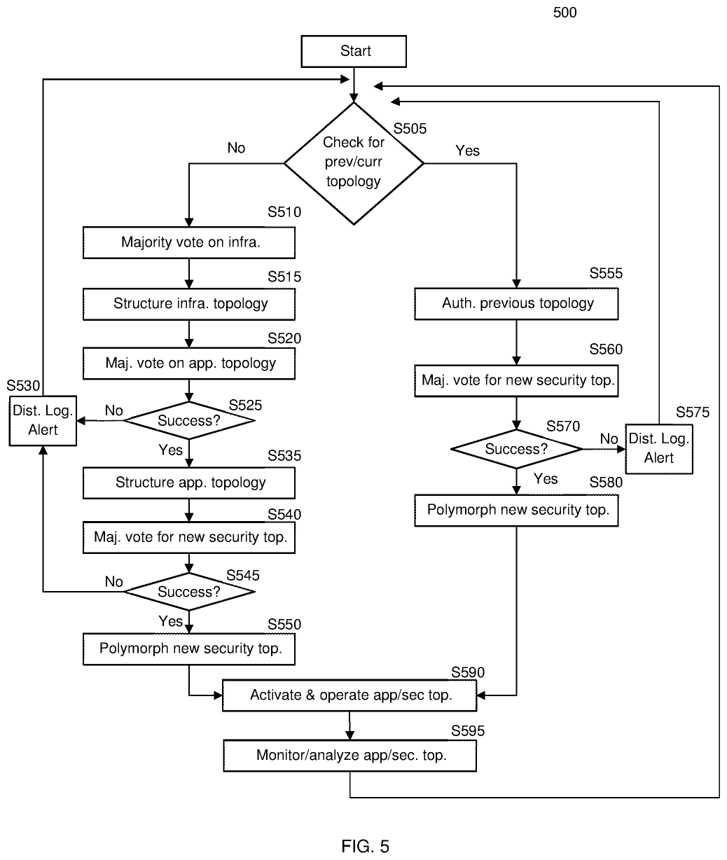

FIG. 5 is an example flowchart 500 illustrating a method of establishing a topology of a proactive polymorphic model. The topology is a model that describes how the various policies, cores, logics, and elements of the proactive polymorphic model connect, interact, and operate with each other.

At S505, it is determined if a current or a previous topology of the proactive polymorphic model exists. A current or a previous topology may be stored, e.g., within a storage or memory of a system, and will describe the current states of such a system. If such a topology does not exist, the process continued at S510; otherwise the process continues as S555.

At S510, a first majority vote is executed to determine what the infrastructure should be. For example, in a proactive polymorphic model, such as the device 200 discussed above in FIGS. 2A and 2B, the topology relates to resource usage, including which policies are executed from a framework list, what polymorphic cores are used, which polymorphic logics are implemented, which resources are selected and how they are mapped, what threshold is required for a majority vote, and the like.

At S515, based on a consensus from a majority vote, a topology for the infrastructure of the device is structured.

At S520, a second majority vote is executed to determine an application to be executed using the chosen infrastructure. At S525, it is determined if the second majority vote returns an affirmative answer. If so, execution continues at S535. Otherwise, a distributed logic alert is generated at S530 and the process continues from S505. In an embodiment, the alert or the signaling is an automated alert sent within a system and recorded in or correlated with the graph of the system for future reference.

At S535, the structured topology is applied to the device.

At S540, third majority vote is executed to determine a new security topology for the chosen infrastructure. A security topology is an application dedicated to security uses. At S545, it is determined if the third majority vote returns an affirmative answer. If so, execution continues at S550. Otherwise, a distributed logic alert is generated at S530 and the process continues from S505. In an embodiment, the alert or the signaling is an automated alert sent within a system and recorded in or correlated with the graph of the system for future reference.

At S550 the proactive polymorphic model is polymorphed to form a new security topology and execution continues at S590.

At S555, if a current or a previous topology of the proactive polymorphic model is determined to exist, the previous topology is authenticated. In an embodiment, authentication includes determining the signature of the previous topology and matching the signature to a signature stored in a distributed network. Authentication may be user specific. Namely, a proactive polymorphic model may include a unique ID, where authentication can only be completed by a preapproved entity. For example, if the proactive polymorphic model with a specific topology is configured and/or trained for client A, client B will not be able to successfully authenticate the topology. In an embodiment, a previous topology includes an infrastructure topology and an application topology previously determined, e.g., by a majority vote, to be executed on the proactive polymorphic model.

At S560, a majority vote is executed to determine if a new security topology is to be created. At S570, it is determined if the majority vote returns an affirmative answer. If so, execution continues at S580. Otherwise, a distributed logic alert is generated at S575 and the process continues from S505. In an embodiment, the alert is an automated alert sent within a system and may be recorded in or correlated with the graph of the system for future reference.

At S580, the proactive polymorphic model is polymorphed to form a new security topology. In an embodiment, the security topology is molded within an application topology, such that the resulting topology in an integration of an application topology and a security topology.

At S590, the application topology and the security topology are activated and operated. In an embodiment, activation can only be successfully completed by a preapproved entity, as discussed above.

At S595, the application topology and the security topology are monitored and analyzed as they are executed by the proactive polymorphic model to ensure successful and secure execution and to ensure no attacks, modifications, infiltrations, and the like are present. In an embodiment, execution cycles and returns to S505.

The various embodiments disclosed herein can be implemented as hardware, firmware, software, or any combination thereof. Moreover, the software is preferably implemented as an application and or system program tangibly embodied on a program storage unit or computer readable medium consisting of parts, or of certain devices and/or a combination of devices. The application and or system program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application and or system program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An attack resilient distributed proactive polymorphic hardware, comprising:
at least one polymorphic core including at least one polymorphic logic, the at least one polymorphic logic adapted to adjust an implementation of a proactive polymorphic model without changing the contextual functionality of the proactive polymorphic model;
a framework list defining at least one policy to be executed by the proactive polymorphic model; and
a graph designating a historical description of each of the at least one policy executed by the proactive polymorphic model.

2. The proactive polymorphic hardware of claim 1, wherein the at least one polymorphic core adjusts an implementation of the proactive polymorphic model by at least one of: configuring the proactive polymorphic model and training the proactive polymorphic model.

3. The proactive polymorphic hardware of claim 1, wherein the implementation of the proactive polymorphic model includes executing the at least one policy of the proactive polymorphic hardware based on a decision mechanism and at least one of: a neuron and a gate.

4. The proactive polymorphic hardware of claim 3, wherein the decision mechanism is based on a finite state machine (FSM), and wherein a neuron is included within a polymorphic core.

5. The proactive polymorphic hardware of claim 4, wherein the neuron is based on trainable logics, including as least one of: a perceptron, a weighted trainable logic, a logical configuration, and an FSM based trainable mechanism.

6. The proactive polymorphic hardware of claim 1, wherein any subsequent policy selection by the proactive polymorphic hardware is based on previously selected policies which are described and stored in the graph.

7. The proactive polymorphic hardware of claim 1, wherein the framework list includes at least one of: a framework for generation of a finite state machine (FSM), a majority vote mechanism, an authenticator, one or more traps, an activation module, and a unique identification.

8. The proactive polymorphic hardware of claim 7, wherein the traps include at least one of: a honeypot, a canary logic, and a hooking logic.

9. The proactive polymorphic hardware of claim 8, wherein the majority vote policy is a policy determining a predetermined majority vote threshold of the at least one polymorphic core, wherein the predetermined majority vote threshold is required for execution of a policy by the proactive polymorphic hardware.

10. The proactive polymorphic hardware of claim 1, wherein the proactive polymorphic hardware further comprises:
a self-trusted distributed polymorphic fabric, wherein the trusted distributed polymorphic fabric is configured to provide a secure interface between the at least one polymorphic core, the framework list, and the graph.

11. The proactive polymorphic hardware of claim 1, wherein the proactive polymorphic hardware is further connected to a distributed network, wherein the distributed network includes additional proactive polymorphic hardware.

12. The proactive polymorphic hardware of claim 1, wherein the distributed network is a distributed ledger.

13. The proactive polymorphic hardware of claim 1, further comprising:
adapting a binary of a selected policy, software, or both, to a current architecture of the proactive polymorphic model to produce an output, wherein the output is agnostic to the current architecture of the proactive polymorphic model.

14. A polymorphic core, comprising:
at least one hardware logic configured to execute specific functions of a proactive polymorphic model; and
a polymorphic logic, wherein the polymorphic logic includes a decision mechanism and at least one neuron.

15. The proactive polymorphic hardware of claim 14, wherein the decision mechanism is based on a finite state machine (FSM), and wherein the neuron is based on trainable logics, including as least one of: a perceptron, a weighted trainable logic, a logical configuration, and an FSM based trainable mechanism.

16. The proactive polymorphic hardware of claim 15, wherein the at least one hardware logic includes at least one of: a framework list read logic, a graph update logic, a majority vote logic, and a policy choice logic.

17. The proactive polymorphic hardware of claim 15, wherein the at least one hardware logic has a polymorphic structure.

18. The proactive polymorphic hardware of claim 14, wherein the polymorphic logic is configured to create polymorphic software to be executed either on a polymorphic logic or on a discrete deterministic logic.

19. A method of establishing a topology of a proactive polymorphic model, comprising:
activating an application topology for a proactive polymorphic model, wherein the application topology is based on an infrastructure topology of the application topology;
activating a security topology of a proactive polymorphic model, wherein the security topology is based on an infrastructure topology.

20. The method of claim 19, further comprising:
determining if a previous topology for the proactive polymorphic model exists;
authentication the previous topology; and
polymorphing the proactive polymorphic model with a new security topology.

21. The method of claim 19, wherein each of the infrastructure topology, application topology, and security topology are determined based on a majority vote.
